(19) United States
(12) Patent Application Publication
(10) Pub. No.: US 2020/0160141 A1
(43) Pub. Date: May 21, 2020

(54) MODIFIED RFID TAGS

(71) Applicant: Konica Minolta Laboratory U.S.A., Inc., San Mateo, CA (US)

(72) Inventors: Randy Cruz Soriano, San Leandro, CA (US); Kazuto Yamamoto, Foster City, CA (US)

(21) Appl. No.: 16/197,712

(22) Filed: Nov. 21, 2018

(51) Int. Cl. G06K 19/077

(52) U.S. Cl. CPC G06K 19/07773

(57) ABSTRACT

An RFID tag having an initial range may be modified to have a reduced or increased range by printing a modification element over the antenna of the RFID tag. The modification element may function as an extension of the antenna or may function to shield the antenna.

### FIELD

This disclosure relates generally to RFID devices, more particularly, to modification of RFID tags.

### BACKGROUND

Radio frequency identification (RFID) is a technology that works on radio frequency signals. An RFID system often comprises three main components: (1) an RFID tag which stores data is usually attached to an article that one desires to identify and/or track; (2) an RFID reader that communicates with the RFID tag using radio frequency signals to obtain data from the RFID tag; and (3) a host data processor that uses the data obtained by the RFID reader from the RFID tag. If the RFID tag is within range of the radio frequency signals (radio waves), a communication link between the two RFID devices is established and the RFID tag replies with data to the RFID reader. Based on this reply, the RFID reader may identify the article.

There are various types of RFID tags. Passive RFID tags do not include a power source, such as a battery. Passive RFID tags rely on power derived from radio waves from the RFID reader to transmit a reply to the RFID reader. Active RFID tags include a power source to power its internal circuitry and to enable transmission of a reply to the RFID reader. Semi-passive RFID tags include a power supply to power its internal circuitry but relies on power derived from the radio waves from the RFID reader to transmit a reply to the RFID reader.

An important factor is range, which refers to the maximum distance between the RFID reader and RFID tag for a reliable communication link between the two RFID devices. The range is affected by various factors, such as background radio frequency noise, surrounding structures that may affect the radio waves from the RFID reader, antenna configurations of the reader and tag, relative orientation (angle) between the reader and tag, and carrier frequency. RFID systems may operate in different frequency bands. In the low frequency (LF) band, a carrier frequency of 125 kHz or 134 kHz, for example, may provide a range up to 10 cm. In the high frequency (HF) band, a carrier frequency of 13.58 MHz, for example, may provide a range up to 1 meter. In the ultra high frequency (UHF) band, a carrier frequency within 860-960 MHz, for example, may provide a range up to 15 meters.

RFID tags are used on a great variety of articles. The articles can be items of clothing for sale in a retail shop, medical devices, and individual components used in a factory, just to name a few. It is often the case that RFID tags manufactured in bulk have the same range. However, articles on which the RFID tags are attached might be stacked within a box, and the box may be surrounded by other boxes when the RFID tags must be read by an RFID reader. To ensure reliable communication, the RFID tags may be over-designed or conservatively designed to work in the most extreme situation that is expected during the useful life of the RFID tags, but such an approach may increase costs significantly. This scenario and others present a need for modified RFID tags tailored for the environment in which they will be used.

### SUMMARY

Briefly and in general terms, the present invention is directed to an RFID tag.

In aspects of the invention, an RFID tag comprises a chip, an antenna configured to transmit data from the chip, and a modification element disposed over the antenna. The modification element comprises any of metal or graphite.

The features and advantages of the invention will be more readily understood from the following detailed description which should be read in conjunction with the accompanying drawings.

### BRIEF DESCRIPTION OF THE DRAWINGS

FIG. 1 is a plan view showing an example RFID tag before modification.

FIG. 2 is a plan view showing an example substrate on which is secured the RFID tag and other RFID tags before modification.

FIGS. 3 and 4 are plan views showing example modification elements applied to the RFID tag to increase and decrease range.

FIG. 5 is a diagram showing an example system for modifying the RFID tag.

FIG. 6 is a diagram showing an example modification assembly of the system.

FIG. 7 is a plan view showing images printed on one side of the substrate.

FIG. 8 is a plan view showing modification elements printed over the RFID tag on the other side of the substrate.

FIG. 9 is a plan view showing a coating and an adhesive applied on the same side of the substrate as the RFID tags, and showing the result after the substrate is folded.

FIG. 10 is a side view along the direction of arrows B-B in FIGS. 3 and 9, showing an example modification element that modifies the RFID tag.

FIG. 11 is a detail view of area C in FIG. 3, showing an example relationship between the modification element and the antenna of the RFID tag.

FIG. 12 is a side view along the direction of arrows D-D in FIG. 4, showing another example modification element that modifies the RFID tag.

FIG. 13 is a detail view of area E in FIG. 4, showing an example relationship between the modification element and the antenna of the RFID tag.

FIG. 14 is an isometric view showing an RFID read environment for which the RFID tag may be modified according to its expected position in the RFID read environment.

FIG. 15 is a flow diagram showing an example process for modifying the RFID tag.

### DETAILED DESCRIPTION

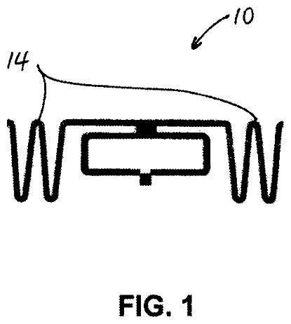

Referring now in more detail to the drawings for purposes of illustrating non-limiting examples, wherein like reference numerals designate corresponding or like elements among the several views, there is shown in FIG. 1 example RFID tag 10 comprising chip 12 and antenna 14 configured transmit data from the chip. Chip 12 is a silicon device (integrated circuit) having pads that are operatively connected to antenna 14, which is a conductive circuit. In the illustrated example, antenna 14 is a dipole (common for UHF) although other antenna designs are possible, such as coiled shapes (common for HF). Circuity provided by chip 12 may include modulators and voltage regulators, as known in the art. Chip 12 may have control logic that includes data encoding and decoding functions, as known in the art.

Chip 12 includes memory, which may be an EEPROM for example, for storing information. Such information may be associated with an article on which the RFID tag will be attached at a later time. Chip 12 and antenna 14 are secured to a substrate, which may be made of paper (e.g., cardstock), polymer film, fabric, or other material.

RFID tag 10 will be modified to increase or reduce its range by printing a modification element over antenna 14. In FIG. 1, RFID tag 10 is in an unmodified state. That is, RFID tag 10 has not been subjected to modification described below. While in an unmodified state, RFID tag 10 is functional in the sense it is capable of powering circuits of chip 12 in response radio waves from an RFID reader. RFID tag 10 has a range, which is the maximum distance between RFID tag 10 and an RFID reader for a for a reliable communication link between the tag and reader.

The term “initial range” refers to the range of RFID tag 10 while in its unmodified state. By definition, an initial range is greater than zero. The term “modified range” refers to the range of RFID tag 10 while in its modified state, which is the state resulting from modification by printing a modification element over antenna 14. The modification element includes metal or graphite, for example. The modification element can have a maximum thickness up to 0.13 mm (about 5 mil) or up to 0.25 mm (about 10 mil), for example.

The range of the RFID tag may be affected by variations in background radio frequency noise (electromagnetic interference), surrounding structures, and other conditions. Thus, the initial range may be determined by testing before RFID tag 10 is modified, such as by using a particular sensor using a known frequency and power under known test conditions (e.g., known amount of background RF noise, known orientation (angle) between reader and tag, etc.). For example, the sensor used for this purpose may be an RFID reader or other type of sensor.

Various test techniques may be used to determine the initial and modified ranges. In a technique referred to herein as position thresholding, the distance of the sensor from RFID tag 10 is adjusted while the sensor emits radio waves. The distance is adjusted until the radio waves induce RFID tag 10 to send a response to the sensor, or until the sensor detects a backscatter signal from the RFID tag. In a technique referred to herein as signal thresholding, the position of the sensor may be fixed (sensor does not move relative to the RFID tag) while characteristics of the radio waves from the antenna of the sensor are adjusted. The radio wave characteristics are adjusted until the radio waves induce RFID tag 10 to send a response to the sensor, or until the sensor detects a backscatter signal from the RFID tag. The radio wave characteristics that result in the response may be used, in formulas and models known in the art, to calculate a value of the initial range.

The initial range is relative to the modified range, which may be determined by testing after RFID tag 10 is modified. Signal thresholding, position thresholding, or other test technique may be used to determine the modified range. For position thresholding, the sensor and test conditions to determine the modified range may be the same as or similar to those used to determine the initial range.

As indicated above, the range of RFID tag 10 depends on a variety of factors. Thus, values for the initial and modified ranges may vary depending on the sensor used for testing. For example, when using one type of sensor under certain test conditions, the initial and modified ranges may be 1.2 meters and 2 meters, respectively. When using another type of sensor under different test conditions, the initial and modified ranges may be 1.5 meters and 2.1 meters, respectively. The initial and modified ranges may be based on multiple tests, and the results of the tests may be averaged to determine initial and modified ranges.

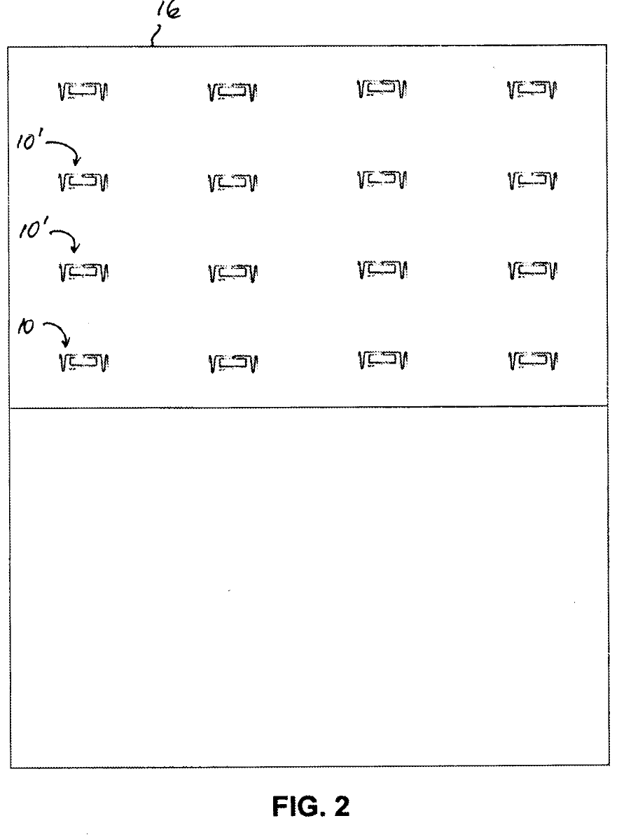

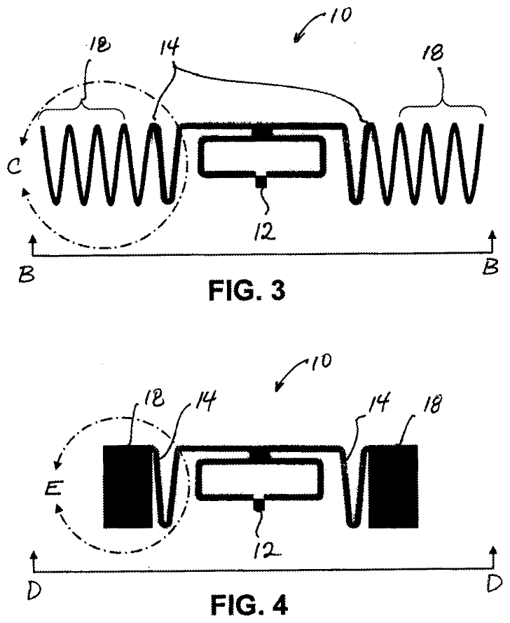

As shown in FIG. 2, substrate 16 may carry RFID tag 10 and other RFID tags 10′ in unmodified states. Other RFID tags 10′ may be identical to or different from RFID tag 10. In this way, multiple RFID tags may be modified together for efficiency. Modification involves printing modification element 18 over antenna 14, as shown in FIGS. 3 and 4. Modification element 18 is made of an electrically conductive material. The conductive material for modification element 18 may be the same or similar material that was used to form antenna 14. For example, the conductive material may be a conductive ink or a conductive paste containing metal particles and/or graphite particles.

In FIG. 3, modification element 18 has been printed over antenna 14 in such a way that modification element 18 makes electrical contact with antenna 14 and increases the range of RFID tag 10. Electrical contact allows modification element 18 to function as an extension of antenna 14. The modified range is greater than the initial range. The modified range may be at least 20% or at least 30% greater than the initial range. In the illustrated example, modification element 18 enlarges antenna 14. Modification element 18 increases the length of antenna 14. Modification element 18 may increase the power gain of antenna 14. The gain is expressed relative to an ideal isotropic antenna or relative to a dipole antenna used as a reference, and may be measured using techniques known in the art.

As previously mentioned, the RFID tag may have a coil shaped antenna. If the RFID tag has a coil shaped antenna, modification element 18 may increase or decrease the number of coil loops in the antenna.

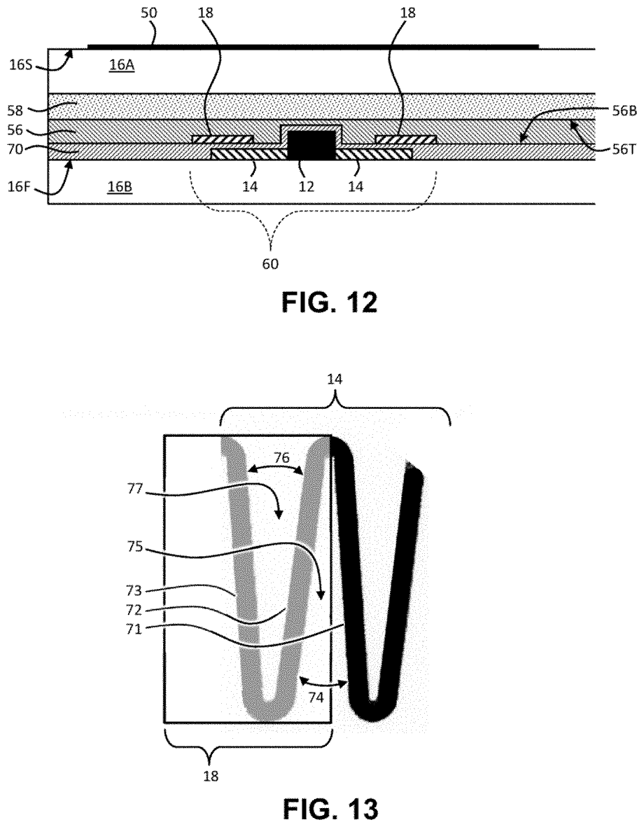

In FIG. 4, modification element 18 has been printed over antenna 14 in such a way that modification element 18 decreases the range of RFID tag 10. The modified range is less than the initial range. The modified range may be at least 20% or at least 30% less than the initial range. Modification element 18 makes electrical contact with antenna 14 such that the number of bends in the antenna 14 are effectively reduced, or modification element 18 does not make electrical contact with antenna 14 such that a portion of antenna 14 is shielded from radio waves by modification element 18. An insulation layer (e.g., layer 70 of FIG. 12) may exist between modification element 18 and antenna 14 to prevent electrical contact. For example, modification element 18 may decrease the power gain of antenna 14.

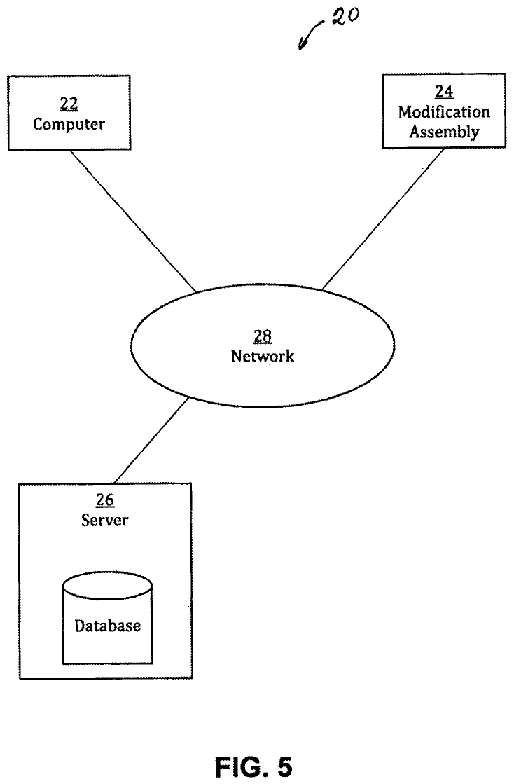

FIG. 5 shows example system 20 for increasing or reducing the range of RFID tag 10. System 20 includes computer 22, modification assembly 24, and server 26. These elements of system 20 communicate via network 28. For example, network 28 may be local area network, wide area network, and/or the Internet. Computer 22 may be a tablet computer, laptop computer, desktop computer, or workstation computer.

Alternatively, computer 22 and/or server 26 may be integrated into and form parts of modification assembly 24. Server 26 may be integrated into and form part of computer 22.

In further aspects, system 20 includes RFID tag 10 secured on substrate 16. System 20 may include RFID tag 10 and other RFID tags 10′ secured on substrate 16.

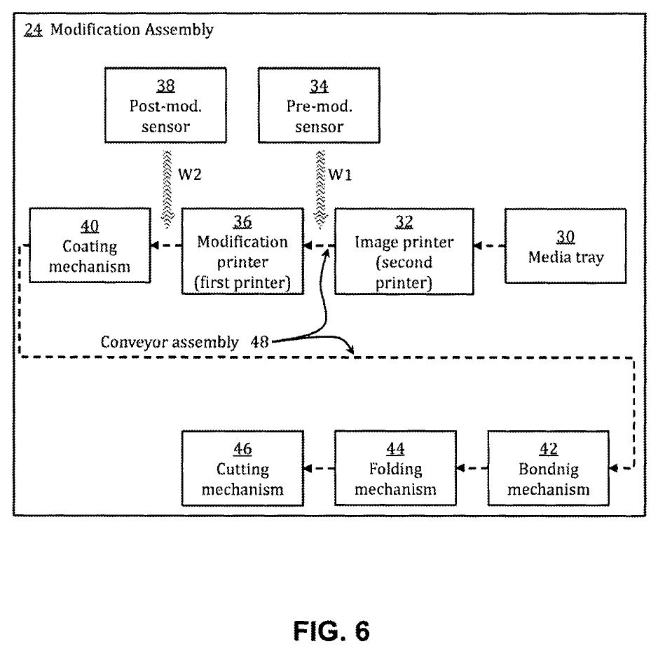

As shown in FIG. 6, modification assembly 24 includes media tray 30, image printer 32 (second printer), pre-modification sensor 34, modification printer 36 (first printer), post-modification sensor 38, coating mechanism 40, bonding mechanism 42, folding mechanism 44, cutting mechanism 46, and conveyor assembly 48. Media tray 30 holds substrate 16 before RFID tag 10 is modified. Conveyor assembly 48 (depicted as a dotted line) extends through modification assembly 24 and includes motors, guides, and rollers, as are known in the art. Conveyor assembly 48 takes substrate 16 from media tray 30 and then conveys substrate 16 across or through image printer 32, pre-modification sensor 34, modification printer 36, post-modification sensor 38, coating mechanism 40, bonding mechanism 44, and folding mechanism 44.

In alternative aspects, modification assembly 24 includes RFID tag 10 secured on substrate 16. Modification assembly 24 may include RFID tag 10 and other RFID tags 10′ secured on substrate 16.

In alternative aspects, any of image printer 32, pre-modification sensor 34, post-modification sensor 38, coating mechanism 40, bonding mechanism 44, folding mechanism 44, and cutting mechanism 46 may be separated from modification assembly 24 while remaining as part(s) of system 20. That is, any of image printer 32, pre-modification sensor 34, modification printer 36, coating mechanism 40, bonding mechanism 44, folding mechanism 44, and cutting mechanism 46 may be present outside of modification assembly 24.

In alternative aspects, any of image printer 32, pre-modification sensor 34, post-modification sensor 38, coating mechanism 40, bonding mechanism 44, folding mechanism 44, and cutting mechanism 46 may be eliminated from system 20.

Conveyor assembly 48 conveys substrate 16 from media tray 30 to image printer 32 (second printer). Image printer 32 prints an image on the second side of substrate 16. The printed image may be text and/or graphics, such as a machine-readable barcode. Image printer 32 may use electrostatic, ink-jet, stamping, roller, or other technique to print the image. Structures for these techniques are known in the art and need not be described herein.

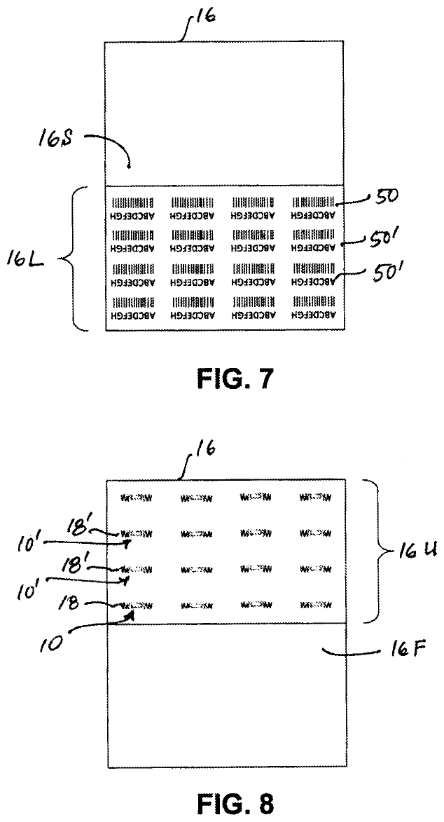

FIG. 7 shows example image 50 printed by image printer 32 on second side 16S of substrate 16. Image 50 corresponds to RFID tag 10, as will become apparent from the folding step described below. When other RFID tags 10′ are on the first side of substrate 16, image printer 32 prints other images 50′ corresponding to other RFID tags 10′. Image 50 and other images 50′ may be identical, or they may be different from each other. The images 50, 50′ are confined to lower half 16L of substrate 16.

Referring again to FIG. 6, conveyor assembly 48 conveys substrate 16 from image printer 32 to pre-modification sensor 34. Pre-modification sensor 34 is used to conduct a test to determine the initial range of RFID tag 10 in an unmodified state. Pre-modification sensor 34 emits radio waves W1 toward RFID tag 10 during the test. Position thresholding, signal thresholding, or another test technique may be used to determine the initial range. Pre-modification sensor 34 may be an RFID reader. RFID readers and sensors for this purpose are known in the art need not be described herein.

Next, conveyor assembly 48 conveys substrate 16 from pre-modification sensor 34 to modification printer 36 (first printer). Modification printer 36 prints modification element 18 over antenna 14. For example, modification printer 36 may print modification element 18 as described for FIG. 3 or FIG. 4. Modification printer 36 may use electrostatic, ink-jet, stamping, rolling, or other technique. Structures for these techniques are known in the art and need not be described herein.

FIG. 8 shows example modification element 18 printed by modification printer 36 (first printer) on first side 16F of substrate 16. Modification printer 36 printed modification element 18 over the antenna of RFID tag 10. Modification printer 36 also printed modification elements 18′ over respective antennas of other RFID tags 10′. Modification element 18 and modification elements 18′ may be identical, or they may be different from each other. Note that the RFID tags are confined to upper half 16U of substrate 16.

Referring again to FIG. 6, conveyor assembly 48 conveys substrate 16 from modification printer 36 (first printer) to post-modification sensor 38. Post-modification sensor 38 is used to conduct a test to determine the modified range of RFID tag 10. Post-modification sensor 38 emits radio waves W2 toward RFID tag 10 during the test. Position thresholding, signal thresholding, or another test technique may be used to determine the modified range. Post-modification sensor 38 may be an RFID reader. RFID readers and sensors for this purpose are known in the art need not be described herein.

In alternative aspects, post-modification sensor 38 is eliminated, and pre-modification sensor 34 is used to determine the modified range of RFID tag 10. For example, conveyor assembly 48 may return substrate 16 to pre-modification sensor 34, or pre-modification sensor 34 may be configured to move on a track to a position downstream of modification printer 36.

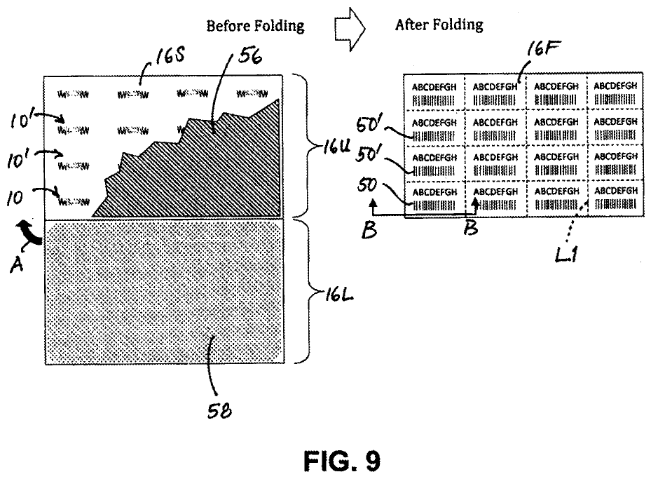

Next within FIG. 6, conveyor assembly 48 conveys substrate 16 from post-modification sensor 38 to coating mechanism 40. Coating mechanism 40 applies protective coating 56 (FIG. 9) on first side 16F of substrate 16 such that a bottom surface of coating 56 covers and contacts the chips, antennas, and modification elements of all RFID tags on substrate 16. Coating 56 may be a thin film that protects the underlying electronic components from moisture, salt, chemicals, temperature changes, and other conditions that may damage the components. Coating 56 may be applied as a wet substance that is dried by coating mechanism 40. When dried, coating 56 may function as an electrical insulator and/or a moisture barrier. Coating 56 may be applied as a dry polymer film that functions as an electrical insulator and/or a moisture barrier. Coating mechanism 40 may use spraying, brushing, stamping, dipping, rolling, or other technique to apply coating 56. Structures for these techniques are known in the art and need not be described herein.

In FIG. 9, coating 56 is illustrated as having been partially removed so that some of the RFID tags are visible for purposes of discussion herein. It is to be understood that coating 56 covers all the RFID tags.

Referring again to FIG. 6, conveyor assembly 48 conveys substrate 16 from coating mechanism 40 to bonding mechanism 42. Bonding mechanism 42 applies adhesive 58 on first side 16F of substrate 16. In FIG. 9, adhesive 58 is confined to lower half 16L of substrate 16. Bonding mechanism 42 may apply adhesive 58 as a wet or tacky substance. Bonding mechanism 42 may use spraying, brushing, stamping, rolling, or other technique to apply adhesive 58. Structures for these techniques are known in the art and need not be described herein.

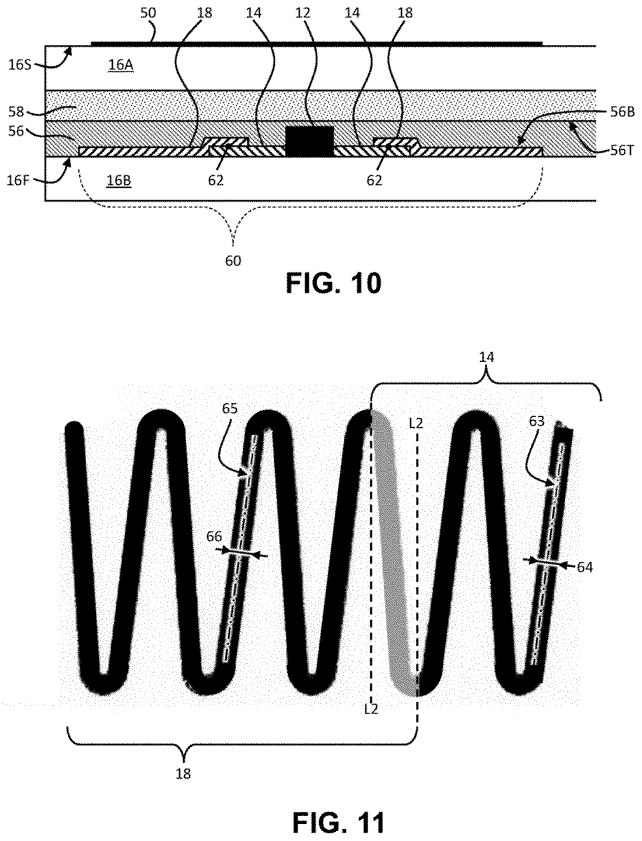

Next, conveyor assembly 48 conveys substrate 16 from bonding mechanism 42 to folding mechanism 44. Folding mechanism 44 folds first side 16F of substrate 16 onto itself as indicated by arrow A. Folding mechanism 44 folds substrate 16 in half. Note that images 50, 50′ (FIG. 0.7) are at lower half 16L of the substrate, and RFID tags 10, 10′ are on upper half 16U of the substrate. Thus, when folding mechanism 44 folds substrate 16, image 50 on second side 16S of the substrate covers area 60 occupied by RFID tag 10 (including chip 12 and antenna 14) and modification element 18 on first side 16F of the substrate, as shown in FIG. 10. That is, RFID tag 10 and its associated image 50 become aligned. Similarly, each of the other RFID tags 10′ and its associated image 50′ become aligned.

Next, conveyor assembly 48 conveys substrate 16 from folding mechanism 44 to cutting mechanism 46. Cutting mechanism 46 separates each of RFID tag 10 and other RFID tags 10′ by cutting substrate 16 along dotted lines L1 in FIG. 9. Cutting mechanism 46 include a blade or cutting die for cutting along dotted lines L1.

In alternative aspects, conveyor assembly 48 may not extend to cutting mechanism 46. Conveyor assembly 48 may terminate at any one of image printer 32 (second printer), pre-modification sensor 34, modification printer 36 (first printer), post-modification sensor 38, coating mechanism 40, bonding mechanism 44, and folding mechanism 44. After the point of termination, a person may convey substrate 16 to the next part of modification assembly 24.

In alternative aspects, pre-modification sensor 34 is not located between image printer 32 and modification printer 36. Instead of the location shown in FIG. 6, pre-modification sensor 34 is located before (upstream of) coating mechanism image printer 32. For example, pre-modification sensor 34 may be located between image printer 32 and media tray 30.

In alternative aspects, post-modification sensor 38 is not located between modification printer 36 and coating mechanism 40. Instead of the location shown in FIG. 6, post-modification sensor 38 may be located after (downstream of) coating mechanism 40. For example, post-modification sensor 36 may be located after cutting mechanism 46.

FIG. 10 is a partial side view in the direction of arrows B-B in FIGS. 3 and 9. FIG. 10 shows a possible configuration of a modified RFID tag after substrate 16 is folded. Modification element 18, chip 12, and antenna 14 are between two portions 16A, 16B of substrate 16. Bottom surface 56B of coating 56 covers and contacts modification element 18, chip 12, and antenna 14. Adhesive 58 is on top surface 56T of coating 56. Adhesive 58 keeps the modified RFID tag sealed and protected between two portions 16A, 16B of substrate 16. Image 50 on second side 16S of substrate 16 covers area 60 occupied by modification element 18, chip 12, and antenna 14 on first side 16F of substrate 16. Modification element 18 does not cover chip 12. Modification element 18 does not cover antenna 14 entirely.

In FIG. 10, modification element 18 and antenna 14 form interface 62 at an area of contact between modification element 18 and antenna 14. Interface 62 provides an electrical conductive path between modification element 18 and antenna 14. Interface 62 is defined by a change in material composition and/or mechanical characteristics. For example, modification element 18 may be made of a composition of copper and a first type of binding agent, and antenna 14 may be made of a composition of copper and a second type of binding agent. Thus, interface 62 is a change in material composition. In a second example, modification element 18 and antenna 14 have similar material compositions; however, an oxidation layer is present on the exposed surface of antenna 14 before modification element 18 is printed. Thus, in the second example, interface 62 is a change in material composition due to the presence of an oxidation layer. In a third example, the modification printing process does not completely fuse the top surface of antenna 14 to modification element 18. This may be evident from a seam or discontinuity where the top surface of antenna 14 meets the bottom surface of modification element 18. Thus, in the third example, interface 62 is a change in mechanical characteristic due to the presence of a seam or discontinuity. A change in mechanical characteristics may also be present in the first and second examples.

FIG. 11 is a detail view of area C in FIG. 3, showing an example relationship between modification element 18 and antenna 14 in FIGS. 3 and 10. Modification element 18 overlaps antenna 14 at the area between two dotted lines L2. The area of overlap is illustrated in gray to distinguish from areas that do not overlap which are illustrated in black. The area of overlap is also the area of contact. Interface 62 (FIG. 10) is at the area of contact. Interface 62 is formed by a linear leg of modification element 18 overlapping and contacting a linear leg of antenna 14. Another leg of antenna 14 has central axis 63 and width 64 perpendicular to central axis 63. Central axis 63 extends through the center of the antenna trace. A leg of modification element 18 has central axis 65 and width 66 perpendicular to central axis 65, which extends through the center of the modification element trace. Width 64 and width 66 may be measured along directions parallel to a flat plane formed by substrate 16. Width 66 of modification element 18 is equal to the width 64 of antenna 14. In this context, the term “equal” encompasses slight manufacturing variations, such that width 66 may be up to 10% greater or less than width 64 for the two widths to be considered equal. Depending on the type of antenna and circuitry of the RFID tag, having equal widths may enable modification element 18 to function effectively as an extension of antenna 14 and increase the range of the RFID tag.

In the illustrated example, central axes 64 and 66 are straight lines since the conductive traces of the antenna and the modification element are straight. In alternative aspects, the conductive traces of the antenna and the modification may be curved or have a radius, as would be for a coil-shaped antenna. In such cases, the central axes would be curved.

In alternative aspects, coating 56 contacts modification element 18 but does not contact chip 12 and antenna 14, as shown in FIG. 12. FIG. 12 is a partial side view in the direction of arrows D-D in FIG. 4. FIG. 12 shows a possible configuration of a modified RFID tag after substrate 16 is folded. FIG. 12 is the same as FIG. 10 except for the presence of insulation layer 70, which covers and contacts chip 12 and antenna 14. Insulation layer 70 may be a thin film that protects the underlying electronic components from moisture, salt, chemicals, temperature changes, and other conditions that may damage the components. Insulation layer 70 may be present when substrate 14 is placed in media tray 30, or a mechanism (similar to coating mechanism 40) may be present between media tray 30 and modification printer 36 for the purpose of applying insulation layer 70. Modification element 18 is printed over antenna 14, though there is no conductive path from modification element 18 to antenna 14 because of insulation layer 70. Absence of a conduct path allows modification element 18 to shield a portion of antenna 14 from radio waves from an RFID reader. Thereafter, coating mechanism 40 applies coating 56 over modification element 18, chip 12, and antenna 14. Bottom surface 56B of coating 56 contacts modification element 18 but does not contact chip 12 and antenna 14 because of insulation layer 70.

FIG. 13 is a detail view of area E in FIG. 4, showing an example relationship between modification element 18 and antenna 14 in FIG. 12. Modification element 18 overlaps antenna 14 at the area illustrated in gray; however, modification element 18 does not contact antenna 14 because of insulation layer 70 (FIG. 12). Antenna 14 comprises first linear leg 71, second linear leg 72 connected to and extending from first linear leg 71, and third linear leg 73 connected to and extending from second linear leg 72. First linear leg 71 and second linear leg 72 are oriented to form acute angle 74 in space 75 between the first and second linear legs. Second linear leg 72 and third linear leg 73 are oriented to form acute angle 76 in space 77 between the second and third linear legs. Modification element 18 does not cover first linear leg 71. However, modification element covers second linear leg 72, third linear leg 73, and space 77 between the second and third linear legs. Depending on the type of antenna and circuitry of the RFID tag, covering portions of antenna 14 in this way may enable modification element 18 to shield antenna 14 effectively and decrease the range of the RFID tag.

In alternative aspects, modification element 18 of FIG. 13 contacts antenna 14 at the area of overlap. An interface would be present at the area of contact between the modification element and second linear leg 72 and third linear leg 73. Depending on the type of antenna and circuitry of the RFID tag, increasing the effective area of antenna 14 in this manner may allow the RFID tag to operate more efficiently.

Referring again to FIG. 5, computer 22 includes processors and memory that allow it to execute computer readable instructions for controlling modification assembly 24 and for performing processes described below.

Pre-modification sensor 34 (FIG. 6) is configured to determine the initial range (Ri) of RFID tag 10, as described above. Computer 22 stores a target range (Rt) and is configured to compare the determined initial range to the target range before instructing modification printer 36 (first printer) to print modification element 18. Computer 22 is configured to determine a configuration of modification element 18 according to a result of the comparison. Thereafter, computer 22 controls modification printer 36 to print modification element 18 over antenna 14 of RFID tag 10 according to the determined configuration.

TABLE I is an example lookup table that may be stored in computer 22 and which computer 22 uses to determine a configuration of modification element 18. The lookup table shows a relationship between additional range (R) and additional antennal length (L) for a particular type of RFID tag having a particular antenna configuration and chip. In this example, computer 22 calculates the additional range from Equation 1 below.

R=Rt−Ri (Eq. 1)

An equation other than Equation 1 may be used to determine R. For example, weighting or correction factors “a” and “b” may be applied according to Equation 2 below.

R=(a·Rt)−(b·Ri) (Eq. 2)

The additional range (R) represents a comparison of the initial range (Ri) and target range (Rt). The lookup table may be developed empirically from many tests performed before the RFID tag is modified. Computer 22 may store many tables, each table being for a particular type of RFID tag. Computer 22 may receive information on the type of RFID tag. In response, computer 22 matches the received information to one of the lookup tables, applies the value of R to the lookup table to determine a value for L. In this way, computer 22 determines L, which represents the configuration of modification element 18.

In alternative aspects, the lookup table may come from the database of server 26. For example, computer 22 may transmit information on the type of RFID tag to server 26, and server 26 matches the information to one of the lookup tables stored in its database, and then transmits the lookup table or a value for L to computer 22.

TABLE I

| | |
|---|---|
| Additional Range, R | Additional Antenna Length, L |

| | | | |
|---|---|---|---|
| −1 | meter | −10 | mm |
| 1 | meter | 20 | mm |
| 2 | meters | 30 | mm |
| 3 | meters | 60 | mm |

In alternative aspects, the relationship between R and L for a particular type of RFID tag may be in a theoretical or empirical model (equation), instead of a lookup table. Several models may be stored in the database of server 26. For example, computer 22 may transmit a value for R and information on the type of RFID tag to server 26. In response, server 26 matches the information to one of the models stored in its database, applies the value of R to the model to calculate a value for L, and transmits the value for L to computer 22. In this way, computer 22 determines L, which represents the configuration of modification element 18.

For example, if the target range is Rt=7 meters and the initial range is Ri=4 meters, then computer 22 may compute the additional range as R=7−4=3 meters according to Equation 1. Using a lookup table or model, computer 22 determines the configuration of modification element 18 to be L=60 mm. Thereafter, computer 22 instructs modification printer 36 to print modification element 18 as a conductive trace that provides 60 mm additional length to the pre-existing length of antenna 14. In addition to or as an alternative to length, the lookup table (or model) may include other characteristics for the configuration of modification element 18. Other characteristics include without limitation: width for printing the conductive trace, the number of meanders or bends of the conductive trace, the number of loops formed by the conductive trace (potentially for an RFID tag having a pre-existing coil design for inductive coupling), the thickness of the trace, and the area size of a paddle tip at the end of the trace (potentially for an RFID tag having a pre-existing coil design for backscatter coupling).

In another example, if the target range is Rt=3 meters and the initial range is Ri=4 meters, then computer 22 may compute the additional range as R=3−4=−1 meter according to Equation 1. Using a lookup table or model, computer 22 determines the configuration of modification element 18 to be L=−10 mm. The negative value means that the effective length of the antenna of the RFID tag should be reduced by 10 mm. Thereafter, computer 22 instructs modification printer 36 to print modification element 18 as a radio wave shield that covers a 10 mm length of antenna 14. In addition to or as an alternative to length, the lookup table (or model) may include other characteristics for the configuration of modification element 18. Other characteristics include without limitation: the number of meanders or bends to be covered by modification element 18, and the number of loops to be covered by modification element 18. Thus, for example, computer 22 may instruct modification printer 36 to print modification element 18 that reduces the number or bends or loops in antenna 14.

The target range may be manually entered into or transmitted to computer 22. The target range may be specified by a customer. The target range may be constant (the same) for all RFID tags on substrate 14, in which case the printed configuration of modification element 18 may be identical for all the RFID tags on substrate 14. The target range may vary among the RFID tags on substrate 14, in which case the printed configuration of modification element 18 may vary among the RFID tags on substrate 14.

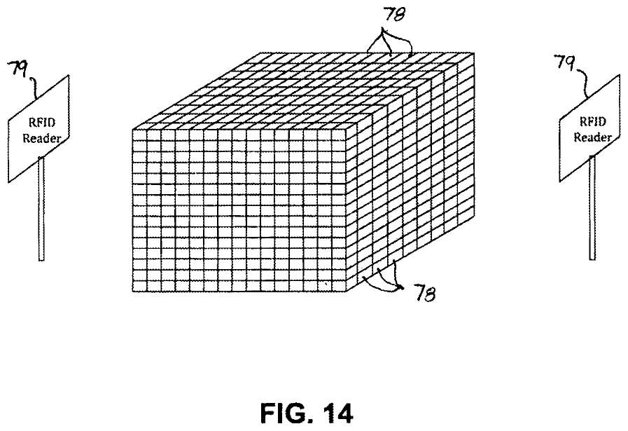

As shown in FIG. 14, it may be possible for RFID tags to be placed in different environments. FIG. 14 shows boxes 78 (articles) on which RFID tags are to be secured. Boxes 78 may be stored on a pallet and transported together from a manufacturing facility to retail facility, for example. To track individual boxes 78 during transportation, the entire group may be passed across an RFID screening station having one or more RFID readers 79. Thus, the target range for a particular RFID tag may be based on the expected environment in which that RFID tag is intended to encounter. RFID tags near the center of the group of boxes may require a greater target range compared to boxes that are closer to the RFID reader. The greater target range may account for the increased distance from the RFID reader and/or interference caused by boxes that surround the RFID tags near the center.

Referring again to FIG. 2, computer 22 is configured to associate RFID tag 10 with a position for storing an article on which RFID tag 10 is to be attached. The position of the article is relative to other articles (e.g., boxes 78 that surround the RFID tag) or relative to an RFID reader to be used later on the RFID tag 10 (e.g., RFID reader 79). Computer 22 is configured to determine the target range according to the position associated with the RFID tag.

TABLE II is an example lookup table that may be stored in computer 22. Computer 22 uses the lookup table to determine the target range according to the position associated with the RFID tag. The lookup table shows a relationship between the position and the target range (Rt). The lookup table may be developed empirically from many tests performed on identical RFID tags before the present RFID tag is modified. Computer 22 may store many lookup tables, each lookup table being for a particular RFID reading environment. For example, the lookup table of TABLE II may be used for the RFID reading environment of FIG. 14, and another lookup table may be used for a different RFID reading environment.

TABLE II

| Position | Target Range, Rt |
|---|---|
| 1. Facing RFID reader | 2 meters |
| 2. All other positions | 5 meters |
| 3. Center region of group of boxes | 6 meters |

For example, computer 22 may associate RFID tag 10 and all other RFID tags 10′ to Position 3, in which case computer 22 determines that target range Rt should be 6 meters. Thereafter, computer 22 determines the configuration of modification element 18 according to Rt, as previously described. That is, computer 22 computes R using Rt and Ri, and then determines configuration characteristic L (and/or other configuration characteristics) from R. Applying Ri=4 meters to Equation 1 gives R=6−4=2 meters. Applying R=2 meters to the lookup table of TABLE I, computer 22 determines the configuration of modification element 18 to be L=30 mm for all the RFID tags on substrate 14.

In another example, computer may associate other RFID tags 10′ to Position 2, in which case computer 22 determines that target range Rt should be 5 meters. Applying Ri=4 meters to Equation 1 gives R=5−4=1 meter. Applying R=1 meter to the lookup table of TABLE I, computer 22 determines the configuration of modification element 18 to be L=20 mm for other RFID tags 10′.

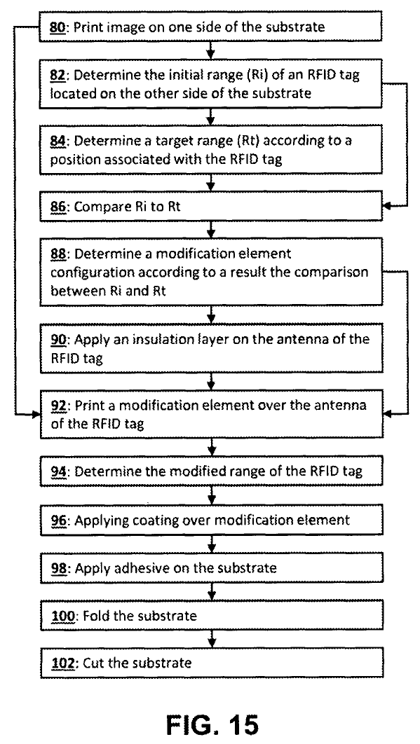

FIG. 15 shows an example process for modifying an RFID tag (e.g., RFID tag 10 described above). The process may begin at block 92, where modification element (e.g., modification element 18 described above) is printed over the antenna of an RFID tag. Optionally, the process may begin at block 80 by printing image 50 on the substrate (e.g., substrate 14), and then the process goes to block 92 where the modification element on the other side of the substrate.

Optionally, the configuration for the modification element may be determined at block 88, and then the modification element is printed at block 92 according to the determined configuration. Optionally, the configuration may be determined by determining the initial range (Ri) of the RFID tag at block 82, for example by using pre-modification sensor 34. Next, Ri is compared to Rt at block 86, and then the configuration for the modification element is determined at block 88 according to a result of the comparison. The determined configuration may specify whether the modification element should make electrical contact with the antenna of the RFID tag. If there should be electrical contact, the process may proceed to block 92 to print the modification element. If there should be no electrical contact, the process may proceed to block 90 to apply an insulation layer (e.g., layer 70) over the antenna (if an insulation layer is not already present), and then proceed to block 92 to print the modification element.

The target range (Rt) may be predetermined. If Rt is not predetermined, Rt may be determined at block 84 according to a position associated with the RFID tag. The position may be for an article (e.g., box 78) on which the RFID tag is to be secured later. The position of the article may be relative to an RFID reader (e.g., RFID reader 79) and/or relative to other articles. Thereafter, the process proceeds to blocks 86, 88, 90, and 92 as previously described.

After the modification element is printed, a coating (e.g., coating 56) is applied on the modification element at block 96. The coating may contact the chip and/or antenna of the RFID tag if an insulation layer is not present on the chip and/or antenna.

Optionally at block 98, an adhesive (e.g., adhesive 58) is applied on the substrate. Next at block 100, the substrate is folded so that the chip, the antenna, and the modification element are disposed between two portions of the substrate. Thereafter, the substrate may be cut at block 102. If multiple RFID tags are present on the substrate, cutting will separate the RFID tags from each other.

Optionally, the modified range of the RFID tag may be determined at block 94 after the modification element is printed. This may be performed for quality control purposes. For example, post-modification sensor 38 may to determine the modified range. In alternative aspects, block 94 may be moved directly after any of blocks 96, 98, 100, and 102. In alternative aspects, the modified range of the RFID tag may be performed while the RFID tag is secured to an article (e.g., box 78), and an RFID reader (e.g., RFID reader 79) may be used to confirm that the modified range of the RFID tag is sufficient.

FIGS. 1-4 and 8-13 show a type of passive RFID tag. It is contemplated that other types of passive RFID tags may be modified according to the method and system described herein. It is also contemplated that modification of range by printing a modification element may be formed for semi-passive and active RFID tags.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. A radio frequency identification (RFID) tag comprising:
a chip;
an antenna configured to transmit data from the chip; and
a conductive modification element electrically connecting at least one of a plurality of bends and loops of the antenna to reduce a range of the RFID tag.

2. The RFID tag of claim 1, wherein the conductive modification element comprises metal.

3. The RFID tag of claim 1, wherein the conductive modification element comprises graphite.

4. The RFID tag of claim 1, wherein the conductive modification element does not cover the chip.

5. The RFID tag of claim 1, wherein the conductive modification element does not cover the antenna entirely.

6. The RFID tag of claim 1, wherein the conductive modification element contacts the antenna.

7. The RFID tag of claim 6, wherein the conductive modification element and the antenna form an interface at an area of contact between the conductive modification element and the antenna.

8. The RFID tag of claim 6, wherein the RFID tag is configured to respond to an RFID reader emitting radio waves toward the antenna.

9. The RFID tag of claim 6, wherein:
the antenna has a central axis and a width perpendicular to the central axis,
the conductive modification element has a central axis and a width perpendicular to the central axis, and
the width of the conductive modification element is equal to the width of the antenna.

10. The RFID tag of claim 1, wherein the conductive modification element does not contact the antenna.

11. The RFID tag of claim 10, further comprising an insulation layer between the conductive modification element and the antenna, wherein there is no conductive path from the antenna to the conductive modification element.

12. The RFID tag of claim 10, wherein the RFID tag is configured to respond to an RFID reader emitting radio waves toward the antenna.

13. The RFID tag of claim 10, wherein:
the antenna comprises a first linear leg, a second linear leg connected to and extending from the first linear leg, and a third linear leg connected to and extending from the second linear leg;
the first linear leg and the second linear leg are oriented to form an acute angle in a space between the first and second linear legs;
the conductive modification element does not cover the first linear leg;
the second linear leg and the third linear leg are oriented to form an acute angle in a space between the second and third linear legs; and
the conductive modification element covers the second linear leg, the third linear leg, and the space between the second and third linear legs.

14. The RFID tag of claim 1, further comprising a substrate and a coating, wherein the chip, the antenna, and the conductive modification element are disposed between the substrate and the coating, and wherein the coating contacts the conductive modification element.

15. The RFID tag of claim 14, wherein the coating contacts the chip and the antenna.

16. The RFID tag of claim 14, wherein the coating does not contact the chip and the antenna.

17. The RFID tag of claim 14, further comprising a cover and an adhesive, the adhesive disposed between and contacting the cover and the coating.

18. The RFID tag of 17, further comprising a printed image on the cover.

19. A radio frequency identification (RFID) tag comprising:
a chip;
an antenna configured to transmit data from the chip; and
a conductive modification element electrically connecting at least one of a plurality of bends and loops of the antenna and configured to reduce a range of the antenna.

20. A radio frequency identification (RFID) tag comprising:
a chip;
an antenna configured to transmit data from the chip; and
a conductive modification element electrically connecting at least one of a plurality of bends and loops of the antenna such that a portion of the antenna is shielded from radio waves.
